(19) United States
(12) Patent Application Publication
(10) Pub. No.: US 2002/0103873 A1
(43) Pub. Date: Aug. 1, 2002

(54) Automating communication and information exchange

(76) Inventors: Kumaresan Ramanathan, Nashua, NH (US); Manjula Sundharam, Nashua, NH (US)

Correspondence Address: DEVINE, MILLIMET & BRANCH, P.A., 111 AMHERST STREET, BOX 719, MANCHESTER, NH, 03105, US

(21) Appl. No.: 10/061,651

(22) Filed: Feb. 1, 2002

Related U.S. Application Data
(60) Provisional application No. 60/265,743, filed on Feb. 1, 2001.

(51) Int. Cl. G06F 15/16; G06F 17/00

(52) U.S. Cl. 709/206; 707/104.1

(57) ABSTRACT

The system and method automates communication and information exchange, for example, to manage strategic decisions in an organization. A messaging system and method provides a way to capture messages into a data store so that workers in different teams may browse through the messages to understand what their colleagues are doing and why. The archived messages can be browsed to allow the user to view the causes and effects of the message. A system and method for obtaining information provides a way to efficiently query individuals in the organization.

### CROSS-REFERENCE TO RELATED APPLICATIONS

The present application claims the benefit of U.S. Provisional Application Serial No. 60/265,743 filed Feb. 1, 2001, which is incorporated herein by reference.

### TECHNICAL FIELD

The present invention relates to managing strategic decisions in an organization and more particularly relates to automating the exchange of information between workers in an organization.

### BACKGROUND INFORMATION

Over the last two decades, business automation systems have progressed to the point of automating many decisions that relate to operations. For example, supply-chain management systems (I2, SAP and Oracle Financials) and e-business tools (Ariba, IBM, I2, SAP and Commerce One) automatically order supplies by monitoring inventory levels. Procurement software (diCarta and OpenMarket) automatically finds the lowest cost suppliers. Customer Relationship Management systems (Siebel and Oracle) automatically send communications to customers to persuade them to buy. All these automation systems deal with operational decisions because operations are well defined and allow the application of mathematical optimization techniques.

In the absence of business automation systems, managers would spend much of their time manually communicating with other operational units of the business. For example, a warehouse manager would have to manually get reports about production times from a manufacturing manager. Using these reports, the warehousing manager would study his own warehouse inventory levels and determine the minimum safe levels of inventory. Such a manual method is very error-prone and also limits the extent of optimization possible. By automating such exchange of information, business automation systems have yielded significant savings.

Unfortunately, there is as yet no good way to automate strategic decisions. Strategic decisions are taken by thinking about all the issues involved, making a choice and then following-up on the implementation of the strategic choices. While operational management deals with improving the operational measures of business performance (such as inventory levels and utilization), strategic management deals with improving the strategic measures of business performance (such as market share, demand, and customer perceptions). Until now, there has been no good way to automate strategic methods.

When teams work together to solve problems in any organization, they usually use email to discuss the various issues before coming to a conclusion. Unfortunately these discussions are usually lost once the decision has been made.

Consider the following scenario: The CEO asks his/her VP of sales to consult with sales managers and come up with a plan to increase sales in the North-East region of the USA. The managers consult among themselves, with the VP, and with some sales people using email. The VP is not involved with all of these conversations, but he/she gets a report from each manager. The VP merges these reports into a single plan, which is sent on to the CEO.

The situation described above has some problems. If the CEO wants to see what each manager said, the email system will not let him/her. Similarly, the VP has no way of knowing the conversations between the managers and the individual salespeople. The situation is somewhat similar to the game in which a chain of people whisper stories down the chain, and when the last person in the chain calls out the story, it is quite different from what the first person in the chain said. It is quite possible that important issues raised by individual sales people are lost along the chain of command before reaching the CEO.

Though email is used by almost all knowledge workers, and though workers spend a large part of their time writing and responding to emails, there is as yet no way to convert emails into a corporate asset that can be referred to later. Examples of current email and messaging systems include Lotus Notes, Microsoft Exchange, Microsoft Outlook, Netscape Messenger and Collaboration Servers, Groove Networks, Microsoft Messenger, and AOL Instant Messenger.

Email has been a method of communication within organizations for the last few years. Email is primarily a tool for communication from one person to a few others. Broadcast email may be used for communication from one person (or party) to a large number of recipients, but such recipients do not always welcome the email. Broadcast email may be welcomed by recipients depending on the nature of the email. For example, newsletters that the recipient has signed up for will be welcomed while unwanted marketing email is usually rejected. Unwanted broadcast email is usually termed “spam.”

Broadcast email is put to limited use within organizations. Great care is taken to ensure that the number of recipients is as small as possible. Care is also taken to ensure that the recipients are very likely to value the broadcast email's contents.

The reason broadcast email (or any unwanted/irrelevant email) can annoy the recipients is because it wastes their attention. Typically workers who regularly send and receive email are under pressure to utilize their time and attention most effectively. To read and reject an irrelevant email wastes their time and annoys them by making them focus their attention on useless material. It is unfortunate that broadcast email has this potential to waste people's time when email has such potential to be used as a method to share knowledge within an organization.

For example, consider the following scenario: A senior executive who needs some sales data while traveling might send a broadcast email to the whole company from his/her wireless email device. The first time the executive sends such a request; many people are likely to respond. However if the executive were to get into the habit of sending such email requests regularly, fewer and fewer employees would respond and some might even complain about the “spam”.

Each time the executive sends an email, he/she is using the time of all the recipients. Even if the recipient is away on vacation, the message will wait in the recipient's mailbox and waste time upon his/her return. If more than one recipient responds to the request, all the extra responses represent wasted effort since the executive needs only one answer.

Unlike email, newsgroups are usually a good way to ask questions of a large number of people or to disseminate knowledge to a large group of people. However, newsgroups do not guarantee that messages will reach any individual person. If the person reads the newsgroup, then he/she gets the message, otherwise the message will not reach that particular person. This shortcoming is a significant handicap in organizations that wish to disseminate mission-critical information among their employees.

In summary, business automation systems today have only been able to automate operational decisions. Strategic decisions have not been automated because they are considered too difficult for computers. Accordingly, there is a need to identify some of the activities involved in managing strategic decisions and to automate them using general-purpose computers so that less human effort is required. Specifically, there is a need for a method that automates the exchange of strategic information among different teams so that their plans can be aligned with a common goal.

### SUMMARY

According to one aspect of the present invention, a computerized method automates the exchange of information related to strategic decisions within an organization. According to one embodiment of the method, a message data store is provided for storing addressed to computerized devices of individually identified recipients within the organization. A user selection of at least one individual involved in a strategic decision is received from a user including any member of the organization who is affected by the strategic decision. The message data store is searched for at least one strategic information message associated with the individual(s) and not addressed to the user. The strategic information message(s) associated with the individual(s) is retrieved and displayed to the user, whereby the user can adjust plans to align with the individual.

The message information can be stored when messages are sent by the computerized devices of the individuals in the organization. The message information includes at least contents of each of the messages, a date of each of the messages, a sender of each of the messages, and each individually specified recipient of each of the messages. The message information can also include access permissions specified by the sender of each of the messages, and only strategic information messages for which the user has access permission are retrieved and displayed.

The step of searching the data store can include searching the data store for related messages received by a sender of the strategic information message(s) immediately prior to sending the strategic information message. A user selection of the related messages that are likely to be a cause of the strategic information message can be received and the user selected related messages retrieved and displayed.

According to another embodiment of the method for automating the exchange of information, contents of a message and at least one recipient of the message are received from a computerized device of a sender. Message information pertaining to the message is stored including at least said contents of the message, a date of the message, the recipient(s) of the message, and the sender. A message data store is searched and similar messages having similar contents are retrieved. The similar messages are displayed to the sender and the message is transported to a computerized device of each recipient.

According to another embodiment of the method for automating information exchange, contents of a message and at least one recipient of the message are received from a computerized device of a sender. The contents of the message are compared to stored descriptions of duties of other members in the organization to determine additional potential recipients of the message. The additional potential recipients are displayed to the sender, and a user selection of at least one of the potential recipients to add as a selected additional recipient of the message is received. Message information pertaining to the message is stored including at least the contents, a date, the recipient(s), the selected additional recipient(s), and the sender. The message is transported to a computerized device of each recipient and to a computerized device of each selected additional recipient.

According to another embodiment of the method for automating information exchange, a user initiation of an operational action on a computerized device is received. In response to the initiation of the operational actions a list of recent messages received by the user is displayed. A user selection of related recent messages that are causing or influencing the operational action is received, and a link between the related recent messages and the operational action i s stored.

According to another embodiment of the method for automating information exchange, contents of a new message and at least one recipient of the new message are received from a computerized device of a sender. A list of messages recently received by the sender is displayed to the sender, and at least one user selection of the recently received messages is received based on a relationship to the new message. Message information pertaining to the new message is stored together with links to the selected recently received messages, and the new message is transported to a computerized device of each recipient.

According to another aspect of the present invention, a computerized method obtains information from a plurality of individuals. According to one embodiment of the method for obtaining information, an expertise data store is provided including expertise descriptions of individuals. A query is received from a computerized device of a user, and the query is compared with the expertise descriptions in the expertise data store. At least one individual most likely to answer the query is determined, and a message including the query is transported to a computerized device of the individual(s) most likely to answer the query.

A set of individuals can be determined and ordered according to the likelihood of answering the query. The message can then be sequentially transporting to a computerized device of each individual in the ordered set of individuals until at least one individual in the ordered set of individuals answers the query.

According to another embodiment of the method for obtaining information, a query is received from a computerized device of a user, and a determination is made of which individuals are available at the computerized devices to answer the query. A message with the query is transported to a computerized device of at least one of the individuals available to answer the query. The message is removed from the computerized device of the individual if the individual does not answer the query in a predetermined period of time.

According to further aspects of the present invention, software is provided to implement the methods described above.

### BRIEF DESCRIPTION OF THE DRAWINGS

These and other features and advantages of the present invention will be better understood by reading the following detailed description, taken together with the drawings wherein:

FIG. 1 is a schematic diagram illustrating one embodiment of an information exchange system for exchanging information between teams of workers to align their activities and strategic plans with each other.

FIG. 2 is a schematic diagram illustrating another embodiment of the information exchange system with user-authentication and access permissions.

FIG. 3 is a schematic diagram illustrating a further embodiment of the information exchange system with automatic computing of causes for a message.

FIG. 4 is a schematic diagram illustrating another embodiment of the information exchange system with automatic retrieval of related messages.

FIG. 5 is a schematic diagram illustrating one embodiment of an information exchange system for automatically sending copies of a message to people who might benefit from reading the message.

FIG. 6 is a schematic diagram illustrating another embodiment of the information exchange system including a data store in which cause-and-effect relationships are established between archived messages.

FIG. 7 is a schematic diagram illustrating one embodiment of a system for obtaining information by automatically querying people for information according to their expertise.

FIG. 8 is a schematic diagram illustrating another embodiment of a system for obtaining information by automatically and sequentially querying people for information according to their expertise.

FIG. 9 is a schematic diagram illustrating an embodiment of a system for obtaining information by automatically querying people by showing query messages to only those people who are available to answer the query.

FIG. 10 is a schematic diagram illustrating a further embodiment of a system for obtaining information by automatically querying people by ensuring only one user attempts to answer a query at any given time.

FIG. 11 is a flowchart illustrating a method for providing a messaging system with archiving.

FIG. 12 is a flowchart illustrating a method for aligning plans and other activities across different teams.

FIG. 13 is a flowchart illustrating a method of providing an archived message system that provides access control for archived messages.

FIG. 14 is a flowchart illustrating a method of accessing the archived message system when different messages require different permissions for access.

FIG. 15 is a flowchart illustrating a method for automating the exchange of information by determining which messages are likely to have influenced other messages.

FIG. 16 is a flowchart illustrating a method for automating the exchange of information among workers even when workers forget to do so.

FIG. 17 is a flowchart illustrating a method for automating the exchange of information by ensuring that people who need to get some information from others actually do get it.

FIG. 18 is a flowchart illustrating a method for automating the exchange of information by establishing cause-and-effect influences among messages.

FIG. 19 is a flowchart illustrating a method for obtaining information by automatically determining the best people to query.

FIG. 20 is a flowchart illustrating a method for obtaining information by querying people using a computer so that the best people to ask are asked first.

FIG. 21 is a flowchart illustrating a method for obtaining information by asking people in sequence so that the time of people who are not available is not wasted.

FIG. 22 is a flowchart illustrating a method for obtaining information by asking the minimal number of people to obtain an answer in a definite time.

FIG. 23 is a flowchart illustrating a method for automating the exchange of information by determining the operational impact of strategic decisions.

FIG. 24 is a screen shot of one embodiment of a browser that follows chains of cause-and-effect influences.

FIG. 25 is a schematic diagram illustrating how workers are influenced by received messages and how their output actions are affected.

### DETAILED DESCRIPTION OF THE PREFERRED EMBODIMENTS

Without business automation, operational decisions will require a lot of manual communication between people in teams as they adjust their operational plans to optimize performance across the organization. For example, manufacturing teams and warehouse teams exchange numerous reports as they optimize production schedules and inventory re-order times. If such reports are exchanged more frequently, then the degree of optimization that can be achieved is greater. However, data-exchange frequency is limited by the time available to managers to write and exchange such reports.

Operational automation systems provide two main benefits: (1) They automate the communication of operational data between functional units and (2) They apply mathematical optimization techniques to choose the best operational plans. Of these two benefits, the second is unlikely to be obtained in the general case for strategic decisions because humans plan strategy after careful deliberation. Although strategy cannot be completely automated, the systems and methods described in this application achieve automation of many aspects of communication and information exchange. These systems and methods can be used to achieve automatic exchange of strategic data between functional units and among different teams, thereby improving organization-wide optimization of strategic performance measures.

One method described herein works on the following general principle: If teams can exchange strategic information among themselves without requiring a large effort in writing reports, then they will be better able to align their plans with each other. Such an alignment would ensure that strategic planning and implementation is optimized across the entire organization. Since much strategic information is already in electronic form (e.g., as emails or as documents) automating the exchange of such information between teams is possible.

One example of this method of exchanging information allows us to view past emails that led to a decision or action, allowing an audit trail of why a decision was taken to be captured. Further, since we are capturing knowledge at its source, there is less chance of it being corrupted while traversing the reporting hierarchy.

Organizations use email as one way to communicate. Most emails are exchanged within teams among individuals or workers who know each other well and work together often. Communication between teams is usually between managers of those teams as they try to coordinate the work performed by their workers. For example, a marketing manager may give a list of product enhancement requests to an engineering manager. The engineering manager then splits the tasks into portions and assigns each portion to members of the engineering team.

The problem with this situation is that an engineer depends on the engineering manager to document all enhancement requirements. The engineer does not have access to the discussions within the marketing team that led to the original enhancement request. So there is an increased burden on managers to act as a liaison between workers in different teams.

One method described herein alleviates this problem by allowing workers in one team to read email discussions in other teams. So they can understand the reasoning behind the actions of workers in other teams. Therefore they can better align their own actions with the actions of other teams.

Workers in a team use email to discuss strategic decisions. This invention collects information from such emails and shares it with workers in other teams or functional units. These emails represent the reasoning behind decisions. Viewing them helps others understand the team's strategy and adjust their own plans to match. So workers are empowered to manage the strategic alignment of their own decisions and the burden on managers decreases.

The embodiments of the present invention are now described in detail with reference to the Figures, which illustrate preferred embodiments of the systems and the methods described in this application.

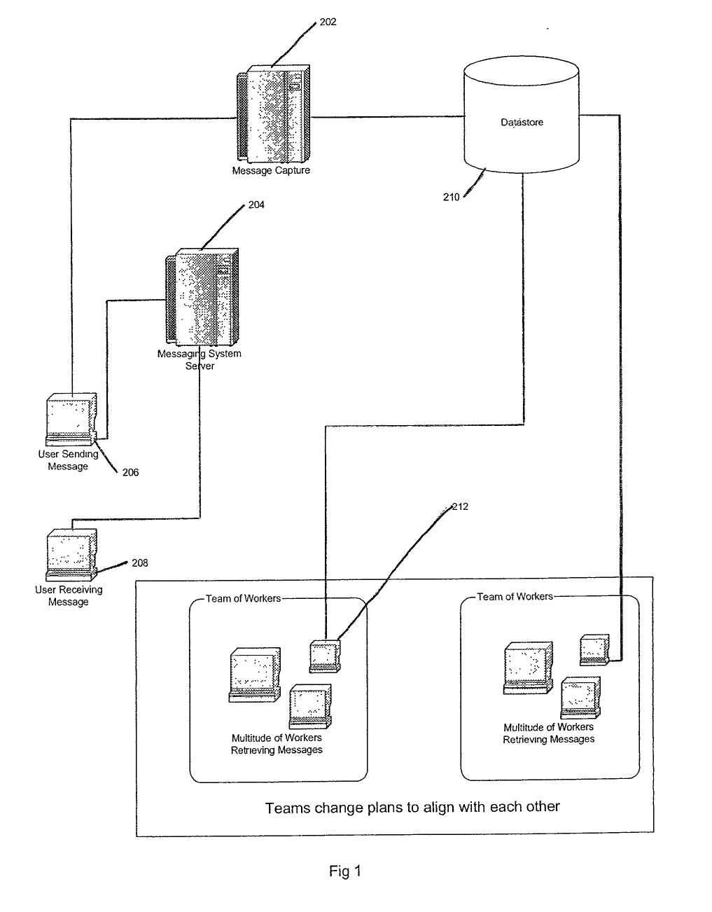

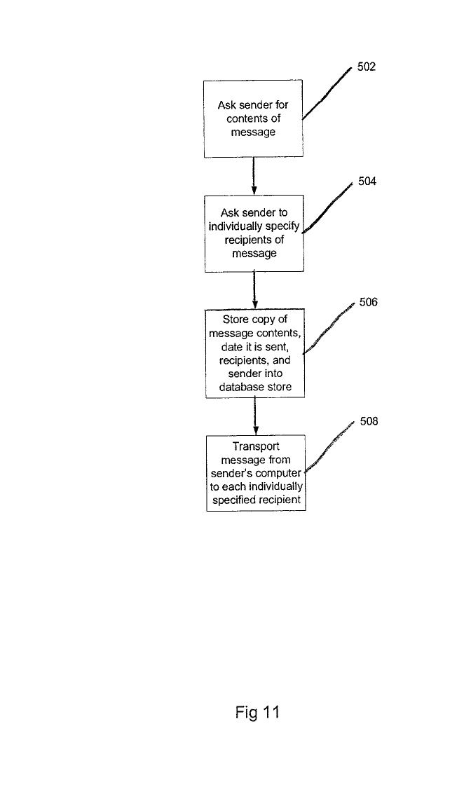

Referring to FIGS. 1, 11 and 12, one embodiment of the information exchange system is described. FIG. 11 shows one method of providing a messaging system such as email that has the ability to archive all messages. An email client such as Microsoft's Outlook obtains the message contents from a sender's computerized device 206, step 502. The user specifies the intended recipients, step 504, and the message is routed, step 508, through a standard messaging system server 204 such as Microsoft Exchange to the recipient device 208. In addition, the message is captured by a message capture system 202 that stores the message information (e.g., contents, date, sender, recipient), step 506, in a message data store 210 such as an Oracle database. The message capture system 202 can be implemented by writing an email client functionally similar to MS-Outlook or Qualcomm's Eudora with the additional feature that it captures messages to the data store 210. The step of storing the message, step 506, and the step of transporting the message, step 508, may be performed in parallel or in any order.

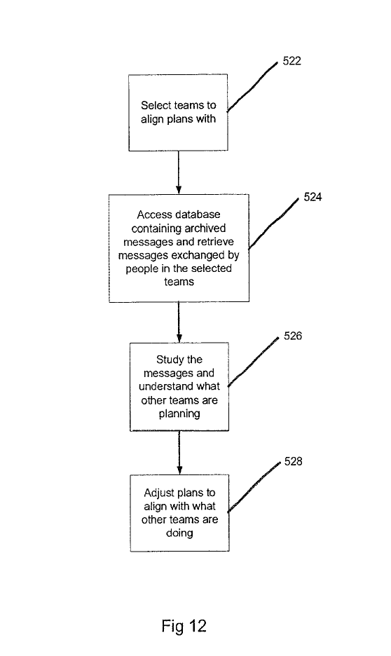

FIG. 12 shows one method of browsing through emails exchanged in other teams. Workers in any team 212 select at least one team they want to align with, step 522, and access the data store 210 to search for and retrieve archived messages containing information related to strategic decisions, step 524. The message(s) are displayed and the workers use the strategic information in the archived messages to understand or infer the strategic plans of the other teams, step 526. The workers can then guide their activities and adjust their own plans to align with the other team(s), step 528.

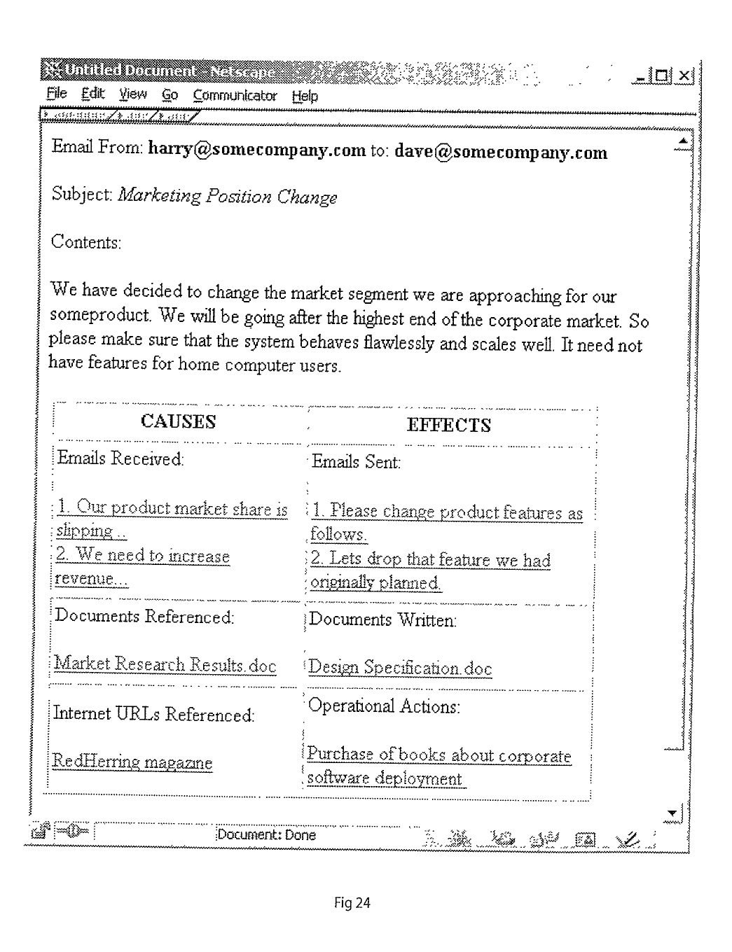

The computerized device used by each worker accesses the data store 210 to retrieve archived messages, for example, using Java Servlets and Java Server Pages along with database access through SQL. The retrieved information or archived messages can be displayed in a standard web browser using HTML. FIG. 24 shows one embodiment of an email browser used to access and display the archived messages, as will be described in greater detail below.

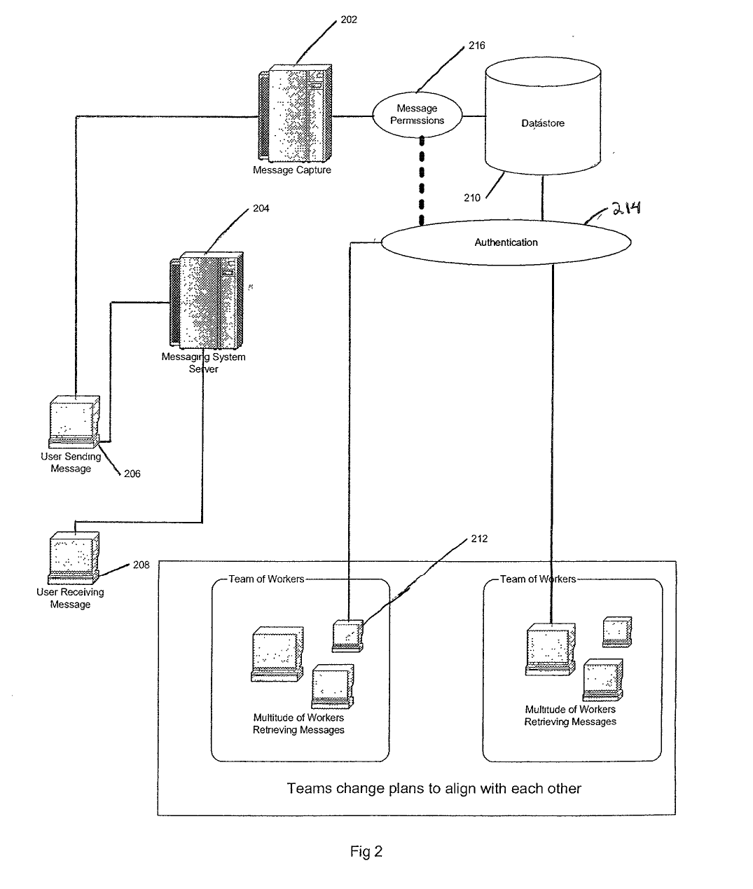

Referring to FIGS. 2, 13 and 14, another embodiment of the information exchange system is described. In this embodiment, the sender of an email may place restrictions on who may view the email, step 532, and store the access permissions with the message information in the data store 210, step 534. This can be implemented by storing permission information in a new table-column along with every message record in the database. Access control is enforced by the JSP and Java servlets that authenticate the user before sending the data to the user. Standard authentication based on a username/password can be used.

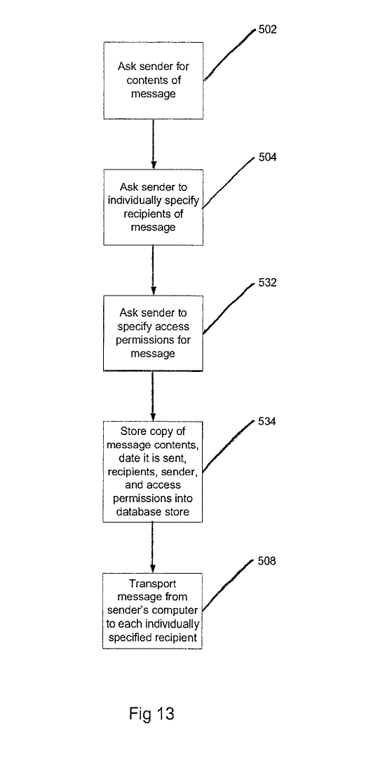

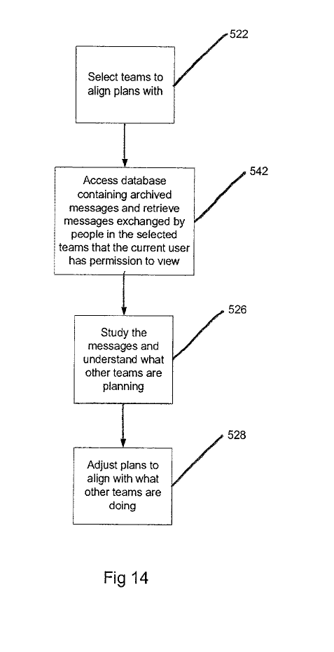

For example, a vice-president may not want all his/her emails to be viewable by non-supervisors. So the vice-president may give browsing permission only to people at vice-president level or up. FIG. 13 shows a method similar to FIG. 11 but modified to collect permission settings from the sender, step 532, and to store the access permissions, step 534. As shown in FIG. 2, the information exchange system collects the permissions 216 and uses an authentication system 214 to enforce permissions. FIG. 14 shows a method browsing email similar to FIG. 2 but modified to enforce the permissions, step 542, such that the only messages retrieved and displayed are those for which a user or worker has access permission.

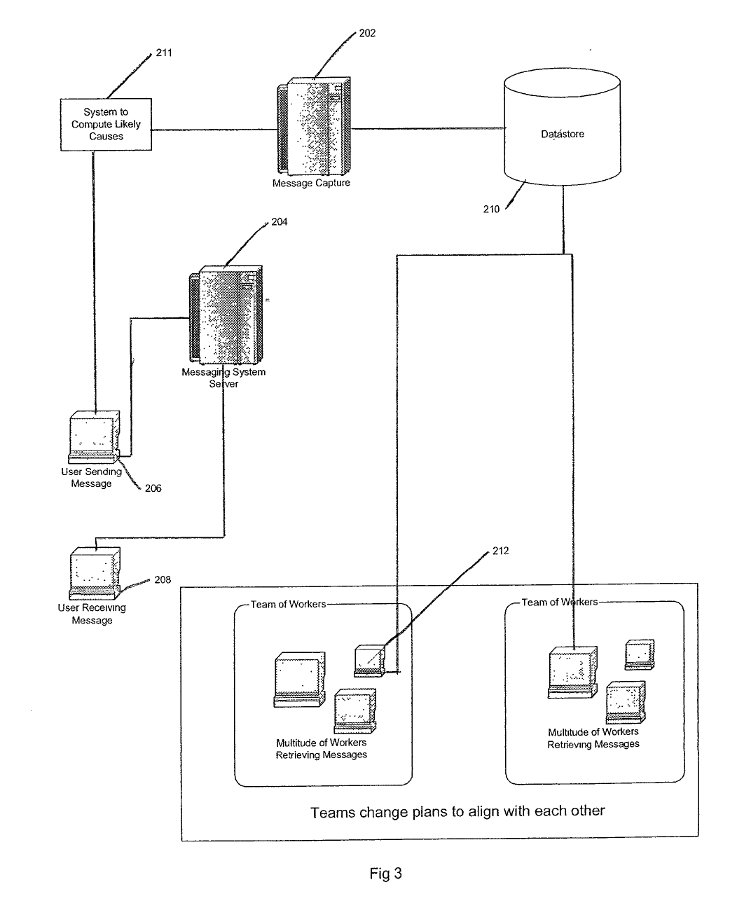

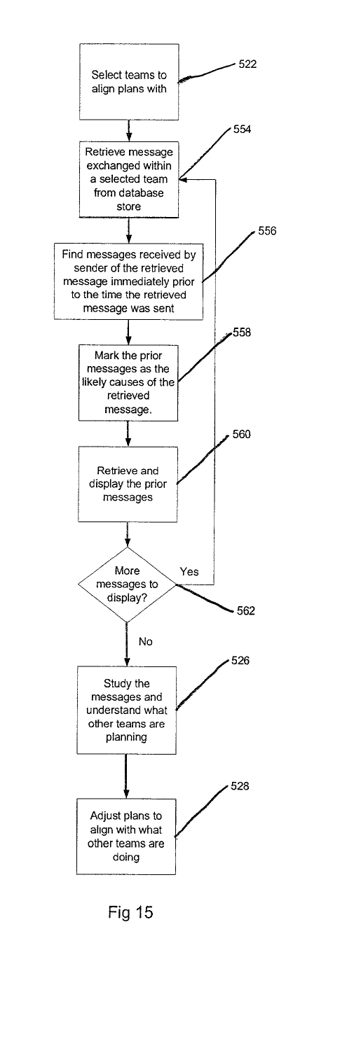

Referring to FIGS. 3 and 15, a further embodiment of the information exchange system is described. When employees receive information from their colleagues or through reading documents, they are influenced by what they read. They might get information, instructions, ideas, and so on from the emails they receive. These influence their subsequent actions. Reading the emails that a person has received often explain that person's subsequent actions.

Since a person's action is usually most influenced by recent emails, FIG. 15 shows a method of understanding a person's actions and inferring their strategic plans by looking at the most recent emails received by that person. For example, if an engineering manager gives some instructions to an engineer, the engineer can try to understand the manager's reasoning by browsing through the emails received by the manager immediately prior to issuing the instructions. For instance, the engineer can see what the marketing people might have told the manager. FIG. 15 shows a method similar to the method of FIG. 12 but with the additional steps of finding related messages received by the sender of the retrieved message immediately prior to the time the retrieved message was sent, step 556, marking or selecting the prior related messages as the likely causes of the retrieved messages, step 558, and retrieving and displaying the selected related prior messages, step 560. These steps can be repeated, step 562.

FIG. 3 shows one embodiment in which software algorithms 211 determine the causes of the message during message capture. To determine the causes, the software algorithms 211 compute which messages the sender received immediately prior to sending the message. If the computation is performed when a message is captured, the results of this computation are stored in the data store to be used when retrieving messages. Alternatively, these computations may be performed when the messages are being retrieved from the data store. The algorithms are implemented using a language such as Java that accesses an Oracle data store using SQL. Messages are displayed to the user through a web browser such as Netscape that renders HTML (see FIG. 24).

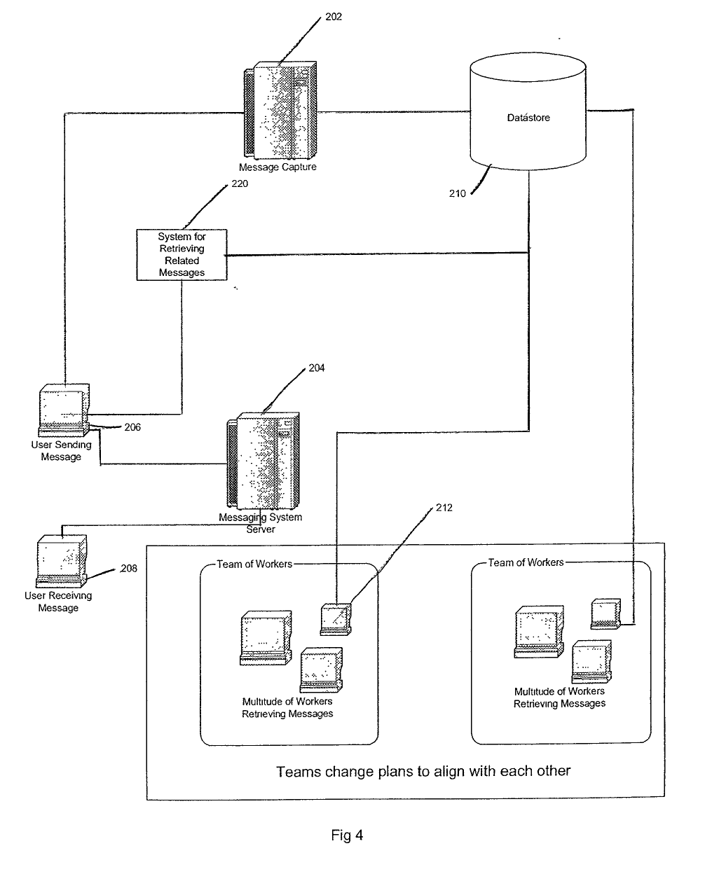

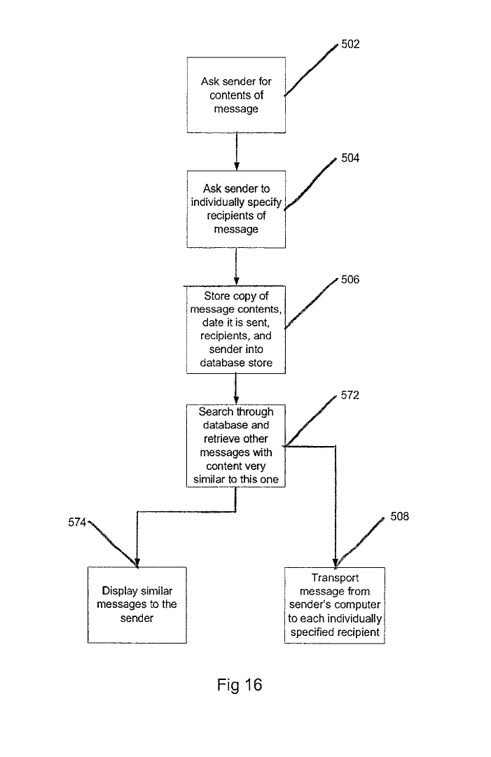

Although workers can browse the archived messages (e.g., emails) by their own initiative, people are sometimes busy with their jobs and may forget to spend time understanding what others are doing. Referring to FIGS. 4 and 16, another embodiment of the information exchange system is described. FIG. 16 shows a method similar to FIG. 11 but when an email is sent or drafted using this system, a system for retrieving related messages 220 (e.g., implemented using a computer) automatically looks for emails that others have exchanged that might be of interest, step 572. It does this by searching the data store, comparing the contents of the sender's email to the messages in the archive, and retrieving messages having similar contents. The related messages are then displayed to the sender, step 574. The user may then study those emails to understand how the actions of others may affect the plans.

In this embodiment, the system for retrieving related messages 220 can be implemented using Java accessing Oracle. The display of the messages to the sender can be implemented through a standard GUI mechanism such as HTML in a web browser. Matching content of the messages can be performed using standard text-matching algorithms that use word occurrences and keywords to compute similarity.

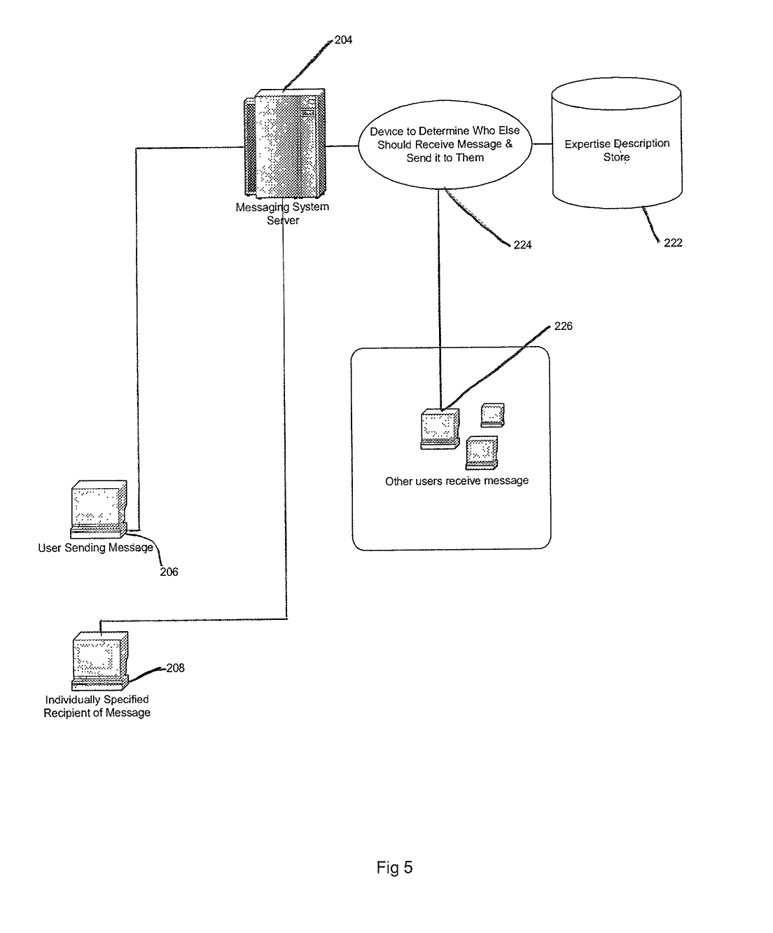

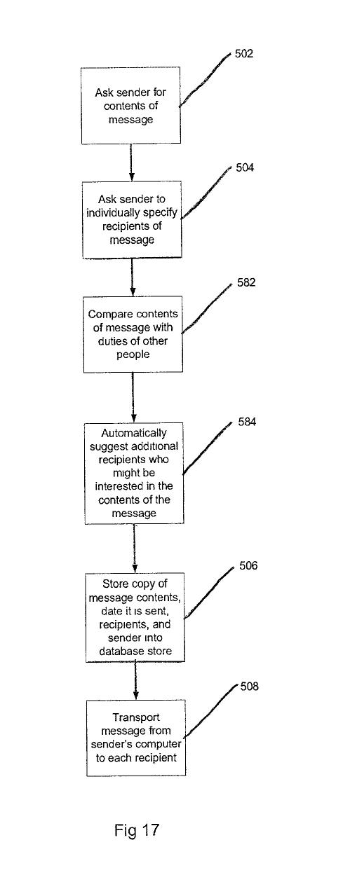

Referring to FIGS. 5 and 17, yet another embodiment of the information exchange system is described. When sending a message such as email, the computer can also compare the contents of the message with the stored descriptions of duties of other workers, step 582. If it finds matches, the computer 224 automatically suggests additional recipients, step 584, by displaying the additional potential recipients to the sender and prompting the sender to select at least one additional recipient 226. When a user selection of the additional recipient(s) is received, the message information is stored, step 506, and the message is transported to the recipients, step 508. The sender is thereby reminded to send copies of email to all those who might be interested in reading it. The duties of the other workers can be provided in advance in an expertise description store 222. For suggesting additional recipients, the preferred embodiment modifies the email client to automatically fill-in email addresses of suggested recipients in the CC: or BCC: fields of the send-email form.

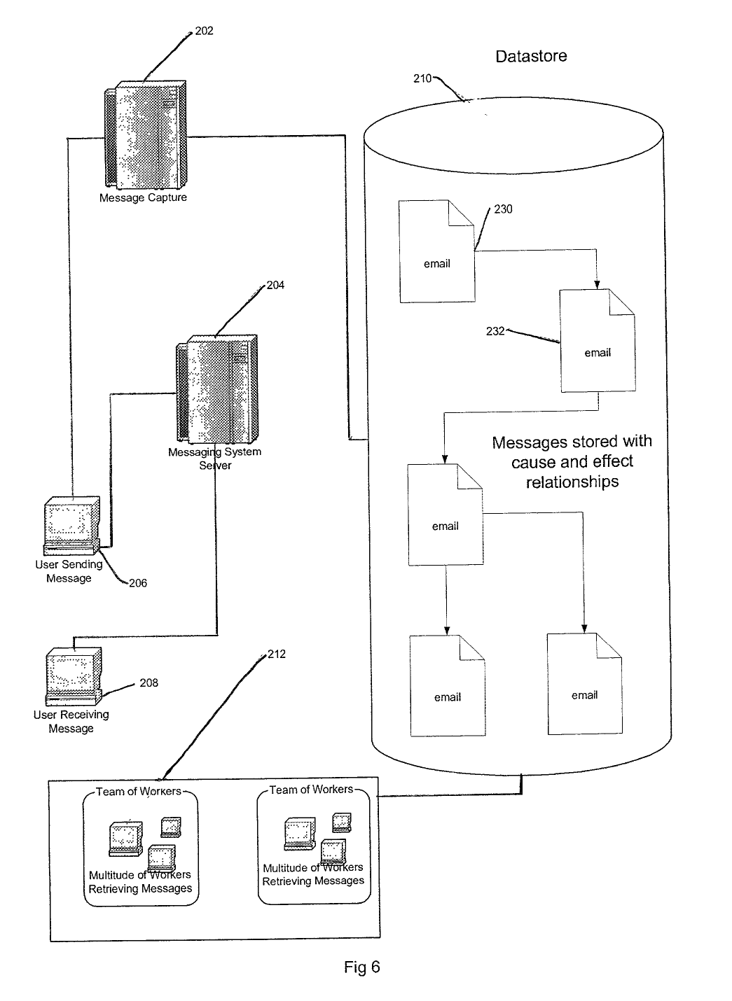

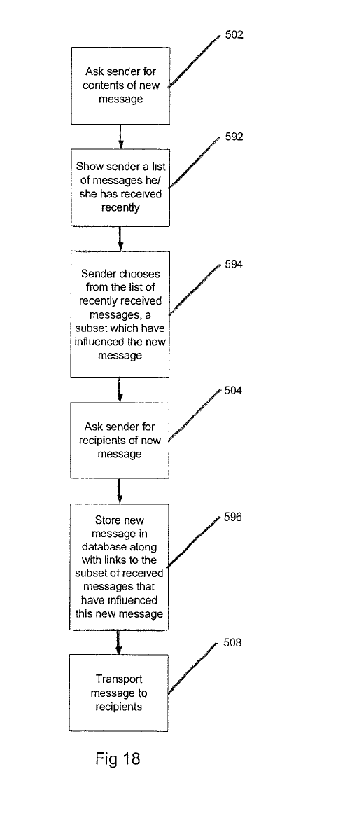

As mentioned above, any email sent is likely to have been influenced by the emails received immediately prior to the time the new message was drafted. Referring to FIGS. 6 and 18, another embodiment of the information exchange system is described in which the worker can specify the emails that have caused him/her to send a new email. This eliminates any fuzziness and helps establish a strong causal link between causes and effects. A list of messages received recently is displayed to the sender, step 592, and the sender selects the messages having a relationship to the new message (e.g., messages that have influenced the new message), step 594. These steps can be implemented by adding functionality to the email client to perform these steps. An email client may be implemented in Java using the JavaMail API or in Microsoft Visual Studio by using MAPI ActiveX controls and CDO. The message information pertaining to the new message is then stored with links to the message(s) that influenced the new message, step 596. Once links between causes 230 and effects 232 have been captured and established in the data store, archive browsers can be used to traverse the causal links, for example, as shown in FIG. 24.

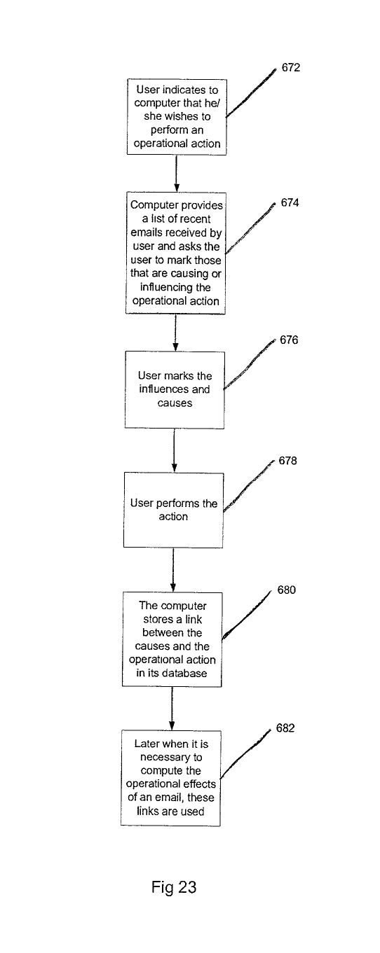

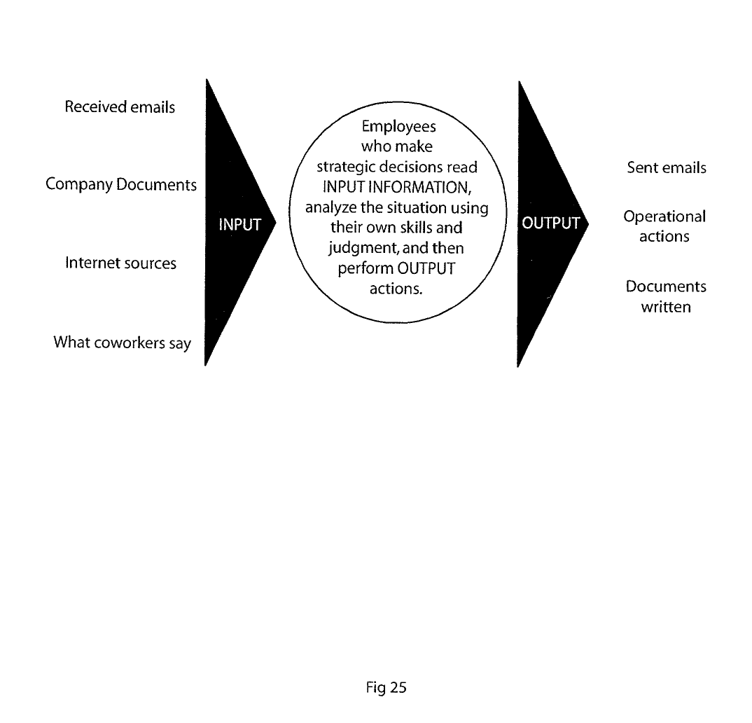

Referring to FIGS. 23 and FIG. 25, a further embodiment of the information exchange system is described in which causal links can also be established between emails received by a person and the actions performed by the person. When the user initiates an operational action, step 672, the computer provides a list of recent emails received by the user and asks the user to mark those emails causing or influencing the operational action, step 674. When the user selects or marks the influences and causes, step 676, and the user performs the action, step 678, the computer stores a link between the causes/influences and the operational action, step 680. For example, if a purchasing agent receives an email from the CFO asking him/her to cut costs, the purchasing agent may change the way supplies are bought from that time on. By capturing a link between the CFO's email and the subsequent actions of the purchasing agent, a connection is established between a strategy expressed in email and the operational effects of that strategy. These connections can be exploited, step 682, to compute the operational effects of strategic changes.

In addition to understanding why others act the way they do, workers also need to gather information from their peers. For example, a marketing manager may need to gather customer feedback from salespeople. An engineer may need to gather ideas for a new design from other engineers and scientists. Such activities may also be automated. Another method described herein provides a practical way to ask a large number of people for information without wasting their time. The recipients of the request are assured that they are not wasting their time by responding to the request because if they answer, theirs will be a useful response. Also, a query preferably does not stay in a mailbox after it loses relevance.

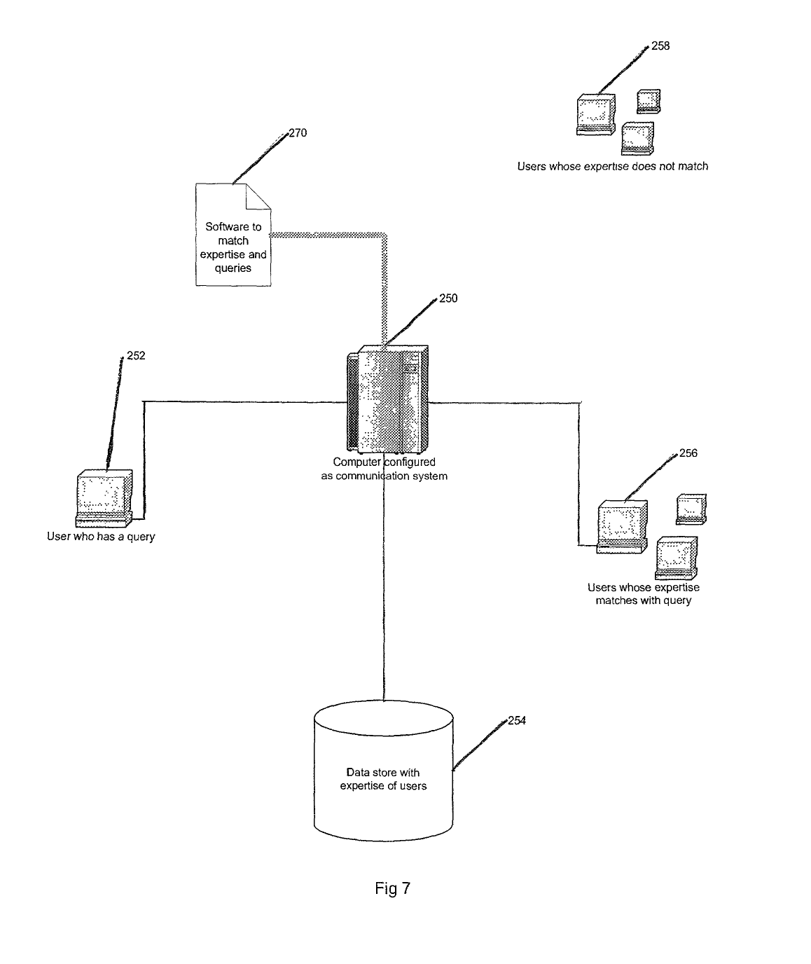

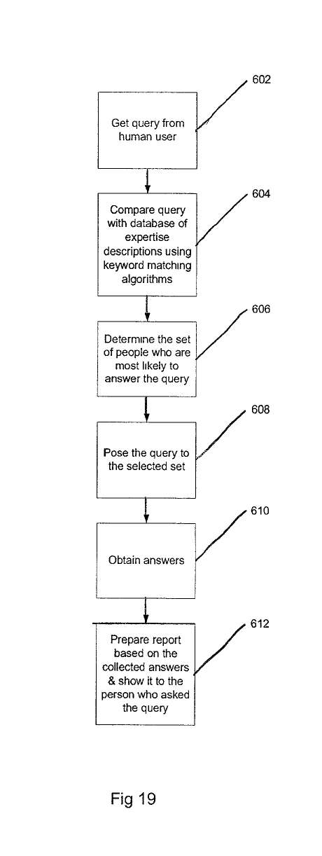

Referring to FIGS. 7 and 19, one embodiment of the system for obtaining information is described. An expertise data store 254 is created with expertise descriptions of individuals. So given some topic, one can determine who is likely to know the most about it. When a user 252 enters a query into the user's computerized device and the query is received, step 602, the software 270 running on the system 250 compares the query with the expertise descriptions in the expertise data store 254, step 604, to determine the people 256 who are most likely to know the answer, step 606. The system 250 poses the query, step 608, for example, by sending a message including the query to at least one of the individuals likely to know the answer. Answers can be obtained, step 610, without having to determine who to ask, and a report can then be prepared based on the collected answers, step 612. The means to ask queries and get answers can be implemented by using a standard email system. The expertise data store can be implemented by using Oracle. The integration between the email system and the expertise data store can be implemented using Java and the JavaMail API.

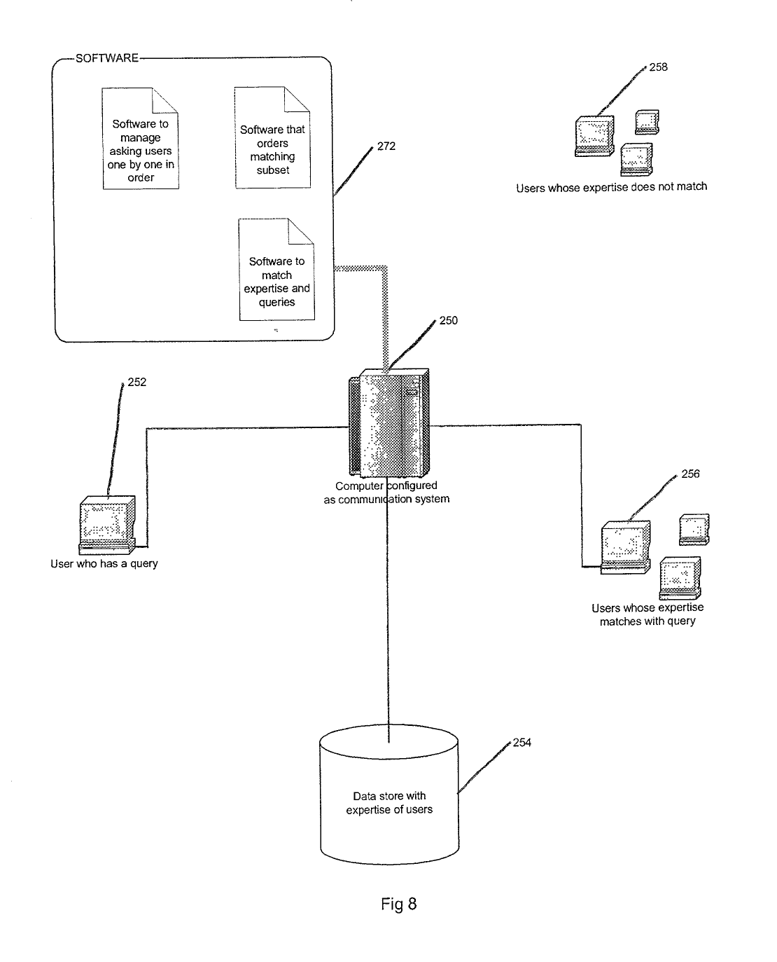

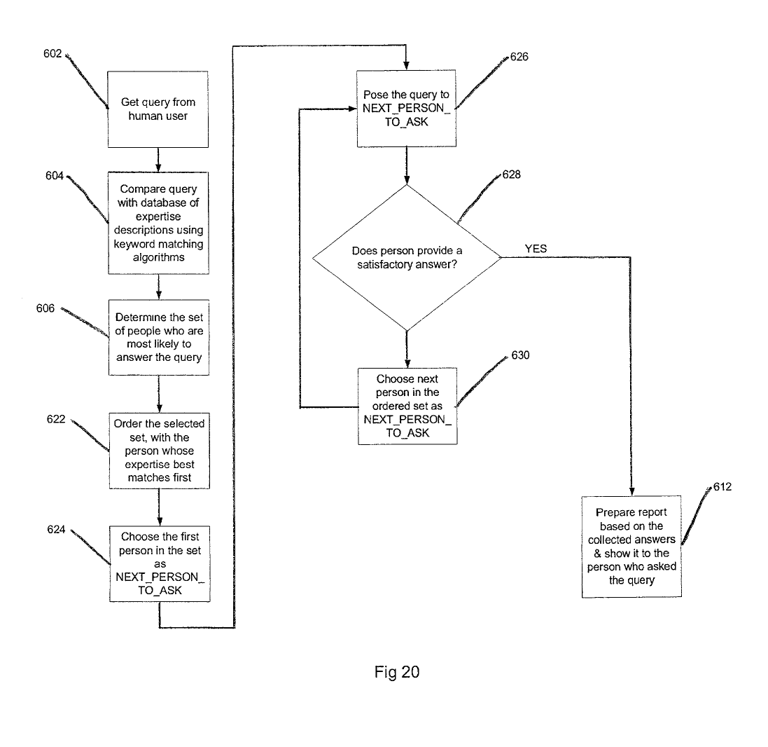

This method can be improved further by ordering the set of experts who might answer your query according to the degree of match or likelihood of answering the query. Referring to FIG. 8 and FIG. 20, this embodiment is described in greater detail. In this modified method, the set of people likely to answer is ordered with the best match first, step 622. The query is then posed to this ordered set of individuals sequentially, for example, by sequentially transporting the messages to a computerized device of each individual in the ordered set of individuals until at least one individual answers. The first individual in the order set is selected as the next individual to ask, step 624, and the query is posed to that individual, step 626. If that individual does not answer (e.g., within a predetermined period of time), step 628, the next individual in the ordered set is selected as the next individual to ask, step 630. The method can be repeated until an answer is received. By following this method, the number of individuals who are asked before someone answers can be minimized. This sequential can be implemented through software 272 on the communication system 250.

If the most likely individual (the first to be queried) does not answer within a time period (e.g., 1 hour), the query is sent to the next individual. With standard email, the first individual may not know that and may then try to answer the question (e.g., after 1.5 hours). This can result in the wasted effort of two people trying to answer the query when one will do.

To avoid wasted effort when broadcasting queries to more than one individual, the system preferably indicates when a query has become obsolete and irrelevant. One way to do this is to delete the query from a recipient's inbox on the computerized device once it becomes irrelevant (e.g., if the recipient does not send an answer within a predetermined time). This deletion can be implemented through CDO programming of Inboxes using Visual Basic on a MS-Exchange email system.

When people are not at their computers, they cannot respond to email queries and sending them queries that need to be answered in a definite period of time results in unnecessary delays. Another preferred method for obtaining information determines who is actually available at their computers and asks them. This method can be implemented by capturing (a) mouse move events (b) window opening and closing events, and (c) keyboard events on each user's computer. If a user's mouse is moving or if the keyboard is frequently being used, it means that user is at the computer. An alternate method is to prompt the user to respond to a dialog window. If the prompt is ignored, then he/she is too busy or is not available. Alternatively, the system can determine that a user is unavailable when a user fails to answer a query within a predetermined period of time.

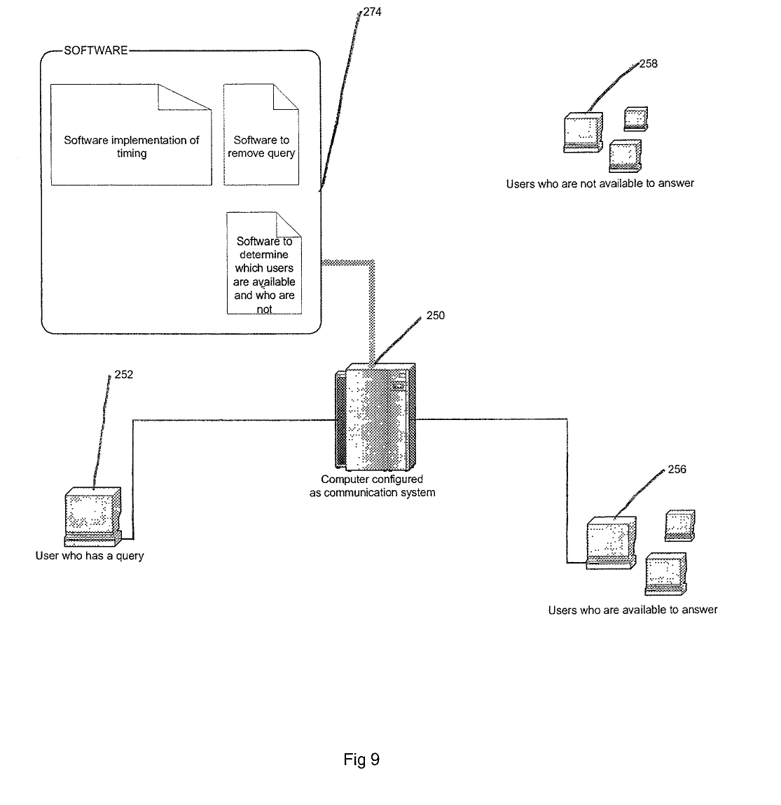

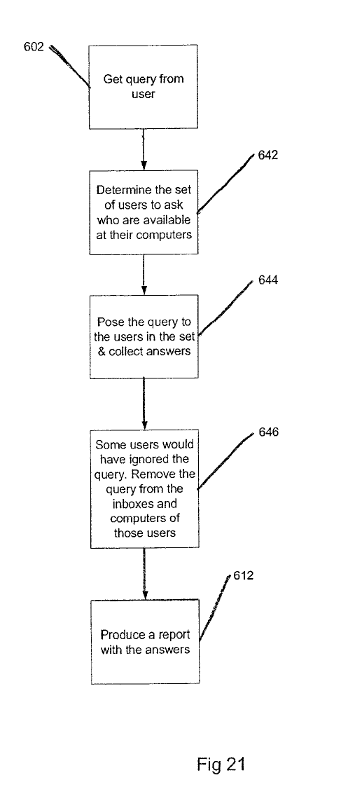

Referring to FIGS. 9 and 21, another embodiment of the system for obtaining information is described with the ability to delete obsolete queries and the ability to determine who is at their computers. This method determines which individuals are available at their computers, step 642, and poses the query (e.g., transports the message) only to those available individuals, step 644. When an individual does not respond to a query in a predetermined period of time, the query will be removed from the individual's computerized device (e.g., removed from the inbox), step 646. Thus, answers can be obtained without unnecessary delays and without wasting the time of the users.

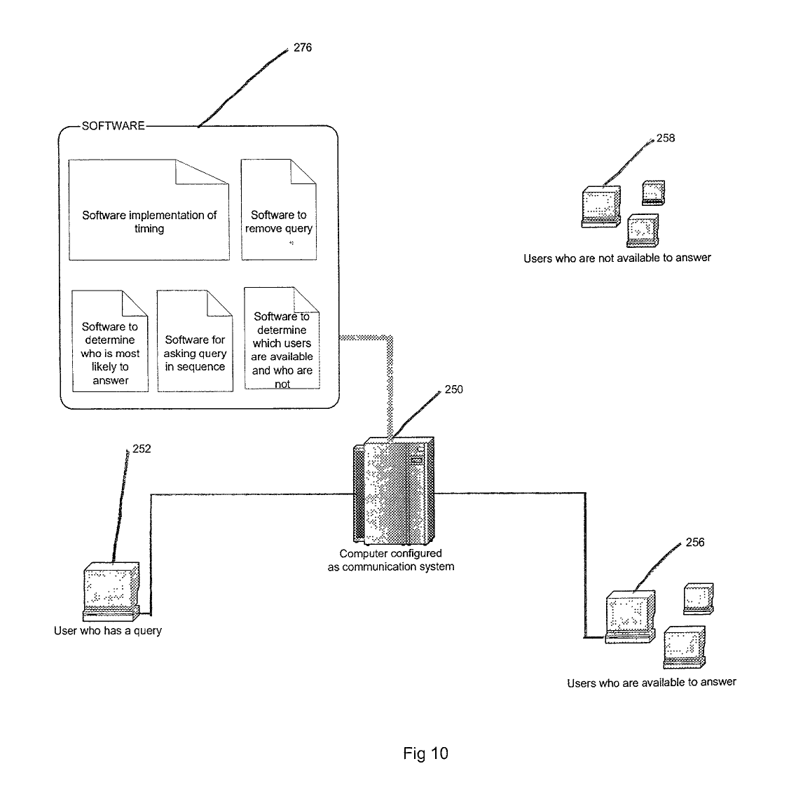

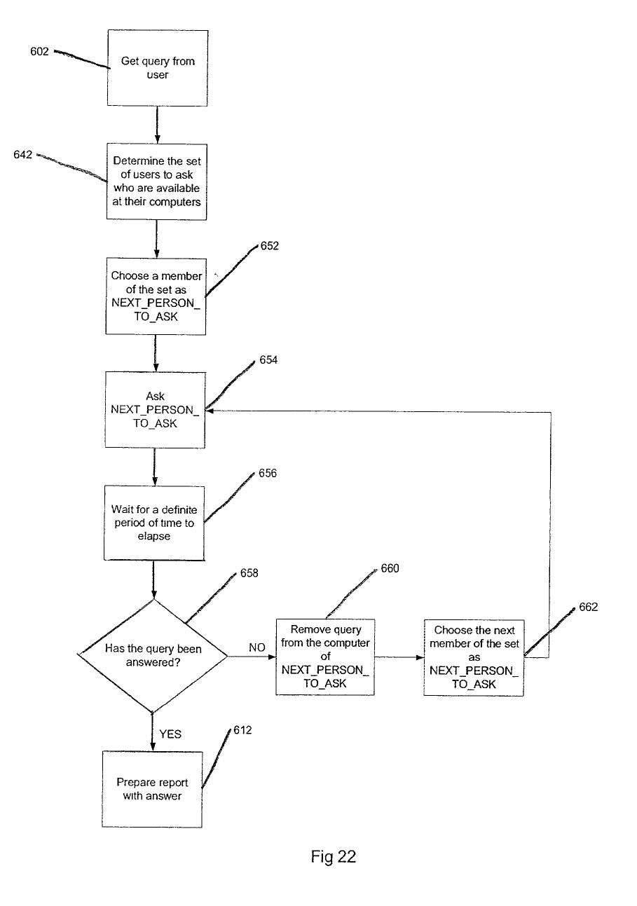

Referring to FIGS. 10 and 22, yet another embodiment of the system for obtaining information is described. The method shown in FIG. 22 is similar to the method in FIG. 21 but asks only one person at a time (e.g., by sequentially transporting messages to a computerized device of each individual), steps 652, 654, 656, 658, 660, 662. Combining the features described above, one method of obtaining information (1) determines who to query, (2) determines the best sequence to query them in (3) finds out which of these people are at their computers, (4) asks these people one by one in sequence (5) removes obsolete queries from inboxes of people who don't respond (or are unwilling to answer) (6) collects the answer and prepares a report for the person who issued the query. Thus, the query is shown to as few people as possible.

The systems and methods for obtaining information described above can be used together with the information exchange systems and method described previously. For example, all messages sent with queries can be archived and the sender can set access permissions. Senders can also provide cause-and-effect data to allow chains of influences to be mapped from strategy to operations. Workers browse this data to manage their own plans and to align themselves with the actions of other workers.

The method described in this application may be implemented in other ways as well. Messaging systems instead of being email based, may be instant-messaging. Instant-messaging transports messages with very little time-lag. In addition to instant-messaging, voice-based communication systems such as telephones, teleconferencing and voice-over-IP can also be used.

In one embodiment, the computerized devices used by the workers are general purpose computers programmed with the software described above. Instead of desktop computers, users may use computerized devices such as wireless telephones, handheld computers, laptops and voice-driven messaging systems. The schematic diagrams show one example of the functional components of invention but are not limited to any particular hardware configuration. For example, the messaging system server 204 and the message capture system 202 can be implemented on the same computer or different computers.

The following are examples of how the preferred embodiments of the invention may be used.

In one example, a sales person who is away from his or her office may send out a message asking for information that would help win a sale. The message is displayed to the sales person's colleagues until one of them agrees to provide the requested information. The person who has agreed to provide the information sends an email to the sales person with the requested information. This request is accomplished without unnecessarily wasting anyone's time.

In another example, a user of a piece of software may send a request for assistance only to those who are using that piece of software at that time. These are people most likely to help the requester.

In another example, a CEO of a business may read a report prepared by a member of his/her executive team. The document references a web url that lists the emails that were exchanged while drafting the report. When the CEO wants to learn more about why a particular course of action is being recommended, the url displays the original discussion in a web browser.

In another example, the invention can be used to share knowledge between suppliers and buyers of industrial goods. A buyer can ask for and receive a list of the emails that were exchanged along various parts of the supply chain. This helps the buyer validate designs and confirm that suppliers further down the chain can really deliver.

In a further example, the discussion being captured in a database can instead be from a software user's group. This allows knowledge to be captured for use by other users.

Accordingly, the systems and methods described herein allow workers to align strategic decisions across different teams and functional units of an organization. Much of the increase in economic productivity over the last decade is attributed to improvements in business automation systems. But until now, business automation systems have only succeeded in automating operational decisions. Strategic decisions have been thought to be too difficult to automate through computerization. Using the systems and methods described herein, communication of strategic information between workers can be automated. By giving workers efficient and automated access to plans, ideas and strategies from their colleagues, workers can align their own actions with those of others.

Although the description above contains many specifics, these should not be construed as limiting the scope of the invention but as merely providing illustrations of some of the presently preferred embodiments of this invention. Modifications and substitutions by one of ordinary skill in the art are considered to be within the scope of the present invention, which is not to be limited except by the following claims.

The invention claimed is:

1. A computerized method for automating the exchange of information related to strategic decisions within an organization, said method comprising the steps of:
providing a message data store for storing messages addressed to computerized devices of individually identified recipients within said organization;
receiving a user selection of at least one individual involved in a strategic decision, wherein a user providing said user selection includes any member of said organization who is affected by said strategic decision;
searching said message data store for at least one strategic information message associated with said individual and not addressed to said user; and
retrieving and displaying to said user said at least one strategic information message associated with said individual, whereby said user can adjust plans to align with said individual.

2. The computerized method of claim 1 wherein the step of providing said message data store comprises storing message information in said message data store when messages are sent by said computerized devices of said individuals in said organization, wherein said message information includes at least contents of each of said messages, a date of each of said messages, a sender of each of said messages, and each said individually identified recipient of each of said messages.

3. The computerized method of claim 2 wherein said message information also includes access permissions specified by said sender of each of said messages, and wherein only strategic information messages for which said user has access permission are retrieved and displayed.

4. The computerized method of claim 1 wherein said step of searching said data store includes searching said data store for related messages received by a sender of said at least one strategic information message immediately prior to sending said strategic information message, and wherein at least some of said related messages are also retrieved and displayed.

5. The computerized method of claim 4 further comprising receiving a user selection of said related messages that are likely to be a cause of said strategic information message, and wherein said user selected related messages are retrieved and displayed.

6. The computerized method of claim 1 wherein said at least one strategic information message is retrieved and displayed using a web browser.

7. The computerized method of claim 1 wherein said message is selected from the group consisting of an email message and an instant message provided by an instant-messaging system.

8. A computerized method for automating the exchange of information related to strategic decisions within an organization, said method comprising the steps of:
receiving from a computerized device of a sender contents of a message and at least one recipient of said message;
storing message information pertaining to said message, said message information including at least said contents of said message, a date of said message, said at least one recipient of said message, and said sender of said message;
searching a message data store and retrieving similar messages having similar contents;
displaying said similar messages to said sender; and
transporting said message to a computerized device of said at least one recipient.

9. The computerized method of claim 8 wherein said message is selected from the group consisting of an email message and an instant message provided by an instant-messaging system.

10. A computerized method for automating the exchange of information related to strategic decisions within an organization, said method comprising the steps of:
receiving from a computerized device of a sender contents of a message and at least one recipient of said message;
comparing said contents of said message to stored descriptions of duties of other members in said organization to determine additional potential recipients of said message;
displaying said additional potential recipients to said sender;
receiving a user selection of at least one of said potential recipients to add as a selected additional recipient of said message; and
transporting said message to a computerized device of said at least one recipient and to a computerized device of said at least one selected additional recipient.

11. The computerized method of claim 10 wherein said message is selected from the group consisting of an email message and an instant message provided by an instant-messaging system.

12. A computerized method for automating the exchange of information related to strategic decisions within an organization, said method comprising the steps of:
receiving a user initiation of an operational action on a computerized device;
displaying, in response to said initiation of said operational action, a list of recent messages received by said user;
receiving a user selection of related recent messages that are causing or influencing said operational action; and
storing a link between said related recent messages and said operational action.

13. The computerized method of claim 12 wherein said message is selected from the group consisting of an email message and an instant message provided by an instant-messaging system.

14. A computerized method for automating the exchange of information related to strategic decisions within an organization, said method comprising the steps of:
receiving from a computerized device of a sender contents of a new message and at least one recipient of said new message;
displaying to said sender a list of messages recently received by said sender;
receiving at least one user selection of said recently received messages based on a relationship to said new message;
storing message information pertaining to said new message together with links to said selected recently received messages, said message information including at least said contents of said new message, a date of said new message, said at least one recipient of said new message, and said sender of said new message; and
transporting said new message to a computerized device of said at least one recipient.

15. The computerized method of claim 14 wherein said message is selected from the group consisting of an email message and an instant message provided by an instant-messaging system.

16. A computerized method for obtaining information from a plurality of individuals, said method comprising:
providing an expertise data store including expertise descriptions of individuals;
receiving a query from a computerized device of a user;
comparing said query with said expertise descriptions in said expertise data store;
determining at least one individual most likely to answer said query; and
transporting a message including said query to a computerized device of said at least one individual most likely to answer said query.

17. The computerized method of claim 16 wherein the step of determining at least one individual most likely to answer said query includes determining a set of individuals and ordering said set of individuals according to the likelihood of answering said query, and wherein the step of transporting said message includes sequentially transporting said message to a computerized device of each individual in said ordered set of individuals until at least one individual in said ordered set of individuals answers said query.

18. The computerized method of claim 16 further comprising the step of determining which of said individuals are available to answer said query, and wherein said at least one individual most likely to answer said query is available.

19. The computerized method of claim 16 further comprising the step of removing said message from a computerized device of said individual if said individual does not send an answer to said query in a predetermined period of time.

20. A computerized method for obtaining information from a plurality of individuals at computerized devices, said method comprising:
receiving a query from a computerized device of a user;
determining which of said individuals are available at said computerized devices to answer said query;
transporting a message with said query to a computerized device of at least one of said individuals available to answer said query; and
removing said message from said computerized device of said individual if said individual does not answer said query in a predetermined period of time.

21. The computerized method of claim 20 wherein the step of transporting said message includes sequentially transporting said message to said computerized device of each of said individuals available to answer until at least one of said individuals available to answer answers said query.
